(19) United States
(12) Patent Application Publication
(10) Pub. No.: US 2024/0203223 A1
(43) Pub. Date: Jun. 20, 2024

(54) ANTI-THEFT SYSTEM AND METHOD

(71) Applicants: Hyundai Motor Company, Seoul (KR); Kia Corporation, Seoul (KR)

(72) Inventors: Yocheol JANG, Suwon-si (KR); Jongbok Lee, Yongin-si (KR); Donghee Seok, Seoul (KR)

(21) Appl. No.: 18/358,664

(22) Filed: Jul. 25, 2023

(30) Foreign Application Priority Data
Dec. 16, 2022 (KR) 1020220177423

(51) Int. Cl. G08B 13/22

(52) U.S. Cl. CPC G08B 13/22

(57) ABSTRACT

An anti-theft system includes a digital key configured to control wirelessly various controls on a mobility device, and a wireless anchor configured to generate a wireless signal, wherein the digital key is deactivated in response to the wireless signal generated from the wireless anchor being detected.

### CROSS-REFERENCE TO RELATED APPLICATION(S)

This application claims the benefit of Korean Patent Application No. 10-2022-0177423, filed on Dec. 16, 2022, which application is hereby incorporated by reference in its entirety.

### TECHNICAL FIELD

The present disclosure relates to a system and method for anti-theft, and more particularly, to an anti-theft system and method for blocking a wireless signal between a digital key that unlocks a mobility device and that starts a vehicle and the mobility device from being stolen.

### BACKGROUND

In recent times, mobility devices have been incorporating a range of information technology (IT) features. This includes the growing trend of replacing traditional physical keys with digital keys that leverage mobile devices like smart phones to operate various functions including opening and closing doors. These digital key technologies establish connections between different components of mobility devices, facilitating control through ultra wideband (UWB) communication or Bluetooth low energy (BLE) communication. Both UWB and BLE are short-range wireless communication methods employed between smartphones and mobility devices. For example, these digital key technologies enable functions such as opening and closing doors of the mobility devices, starting and stopping the engine, and controlling features like the air conditioner or trunk.

In particular, UWB communication and BLE communication are wireless communication protocols that utilize radio waves. These protocols offer specific features such as precise spatial recognition and direction recognition. As a result, a digital key can determine the locations of both the user and the mobility device. When the digital key approaches a location where it can gain control over the mobility device, it becomes activated and can initiate control commands accordingly.

While utilizing a modern digital key to control a mobility device offers convenience, it also presents potential security risks. Hackers can exploit advanced wireless data sniffing techniques, including radio relay attacks, at the link layer level. These techniques involve detecting a signal that activates the digital key and then transmitting the detected signal back to the mobile device. Although there have been studies on preventative measures like time stamp checking methods, completely mitigating the risk of wireless data sniffing remains challenging.

### SUMMARY

The present disclosure is directed to an anti-theft system configured to block sniffing of wireless data by a hacker when a digital key controls a mobility device.

In some implementations, an anti-theft system can include a digital key configured to control wirelessly various controls on a mobility device, and a wireless anchor configured to generate a wireless signal, wherein the digital key is deactivated in response to the wireless signal generated from the wireless anchor being detected.

The digital key may register and store the wireless anchor, and is deactivated in response to the wireless signal of the registered wireless anchor being detected.

The wireless anchor may be spaced apart from the mobility device by a predetermined distance or more.

The wireless anchor may be spaced apart in excess of a distance in which the digital key enables generating a response signal to the wireless signal of the mobility device.

The wireless anchor may generate a wireless signal according to at least one communication method among a Bluetooth low energy (BLU) communication, a ultra wideband (UWB) communication, a wireless internet network communication, and a mobile communication network communication.

The digital key may determine, in response to the wireless signal of the mobility device being detected, whether the wireless signal generated from the wireless anchor is detected.

The digital key may confirm whether the wireless signal generated from the pre-registered wireless anchor is detected.

In response to the wireless signal generated from the wireless anchor being detected, the digital key may be deactivated such that a signal for controlling the mobility device is not generated.

A deactivation of the digital key may prevent the digital key from generating a response signal to the wireless signal of the mobility device.

In some implementations, an anti-theft method includes detecting, by a digital key, a wireless signal emitted from a mobility device to enable various controls of a mobility device, detecting, by the digital key, a wireless anchor configured to generate a wireless signal, and deactivating the digital key in response to the wireless signal generated by the wireless anchor being detected by the digital key.

The anti-theft method may further include registering the wireless anchor to the digital key.

The detecting of the wireless anchor may further include detecting a wireless anchor registered to the digital key.

The wireless anchor may be spaced apart from the mobility device by a predetermined distance or more.

The wireless anchor may be spaced apart in excess of a distance in which the digital key enables generating a response signal to the wireless signal of the mobility device.

The wireless anchor may generate a wireless signal according to at least one communication method among a Bluetooth low energy (BLU) communication, a ultra wideband (UWB) communication, a wireless internet network communication, and a mobile communication network communication.

The deactivating of the digital key may include a signal for controlling the mobility device is not generated.

The deactivating of the digital key may include preventing the digital key from generating a response signal to the wireless signal of the mobility device.

### BRIEF DESCRIPTION OF THE DRAWINGS

FIG. 1 is a diagram illustrating an example of an anti-theft system.

FIG. 2 is a diagram illustrating an example of a conventional hacker sniffing wireless data.

FIG. 3 is a diagram illustrating an example of an anti-theft system.

FIG. 4 is a flowchart illustrating an example of an anti-theft method.

### DETAILED DESCRIPTION

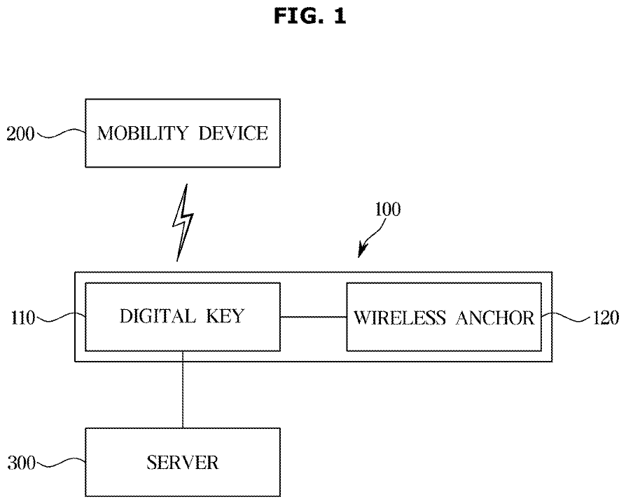

FIG. 1 is a diagram illustrating an example of an anti-theft system.

Referring to FIG. 1 to FIG. 3, an anti-theft system 100 will be described. Herein, the anti-theft system 100 is described based on a vehicle, which is one of mobility devices 200. However, as long as a digital key capable of controlling or opening/closing various devices using wireless communication is used, it should be understood the anti-theft system 100 may be applied.

The anti-theft system 100 can include a digital key 110 and a wireless anchor 120.

The digital key 110 may open and close a door provided in the mobility device 200, turn on or off an ignition of the mobility device 200, and perform various functions included in the mobility device 200 as needed. The digital key 110 may be a device capable of installing applications, such as a smart phone, and may be a device capable of using one or more of a Bluetooth Low Energy (BLE) communication and a near field communication (NFC).

One digital key 110 may be operated in conjunction with one specific mobility device 200, and if necessary a plurality of digital keys 110 may be interworked with one mobility device 200 or a plurality of mobility devices 200 may be interworked with one digital key 110. In addition, a plurality of digital keys 110 may be interworked to a plurality of mobility devices 200.

Furthermore, the digital key 110 may be installed and operated in a device, such as a smart phone, and there may be cases in which the plurality of digital keys 110 are installed in one smart phone. In some implementations, the digital key 110 is described as operating while installed on a smart phone, but is not limited thereto, and may be installed on other devices other than the smart phone as needed.

The digital key 110 may control the mobility device 200. Accordingly, the digital key 110 may communicate with the mobility device 200 via BLE communication, a Ultra Wideband (UWB) communication, a wireless Internet network communication, a mobile communication network, or the like.

Furthermore, the digital key 110 may be manipulated by a user to perform various functions for controlling the mobility device 200, and in some implementations, may be manipulated by the user to set one or more wireless anchors 12.

The digital key 110 may search for the wireless anchor 120 in a vicinity and register the searched wireless anchor 120. In other words, the digital key 110 may use various communication methods to search for the wireless anchor 120 that may be communicatively connected through wireless communication. For example, when two wireless anchors 120 are located around the digital key 110, one wireless anchor 120 may communicate via the BLE communication and the other may communicate via wireless internet network communication. As a result, the digital key 110 may be communicatively connected to one of the two wireless anchors 120 or may be communicatively connected to both of the wireless anchors 120.

The wireless anchor 120 may be an electronic device capable of communicating via a BLE communication, a UWB communication, wireless Internet network communication, or a mobile communication network communication. For example, the wireless anchor 120 may be a home appliance, such as an air conditioner, a refrigerator, or a television that may communicate via a wireless Internet network communication, or a portable location tracker using a UWB communication or a BLE communication. Furthermore, the wireless anchor 120 may be a Wi-Fi access point (AP), a Bluetooth beacon device, a mobile communication base station, or a repeater.

In other words, the wireless anchor 120 may be any electronic device capable of being connected to the digital key 110 via wireless communication.

However, in some implementations, the wireless anchor 120 may be an electronic device disposed at a location spaced apart at least a predetermined distance from the location where the vehicle is located. As will be described later, when the wireless anchor 120 is communicatively connected to the digital key 110, the digital key 110 is deactivated so as not to control the vehicle, so an electronic device separated from the location of the vehicle by a predetermined distance may be used.

For example, in the case of a vehicle being parked in an underground parking lot of an apartment, when a user with the digital key 110 approaches the vehicle, the digital key 110 is communicatively connected with the vehicle to control the vehicle. However, when the wireless anchor 120, such as a mobile communication repeater is placed within a predetermined range of the vehicle and the digital key 110 and the registered wireless anchor 120 are communicatively connected to each other, the vehicle may not be controlled normally due to the deactivated digital key 110.

In other words, the wireless anchor 120 registered to the digital key 110 may be spaced further apart than a distance that allows the digital key 110 to generate a response signal in response to the wireless signal continuously emitted by the vehicle to connect with the digital key 110.

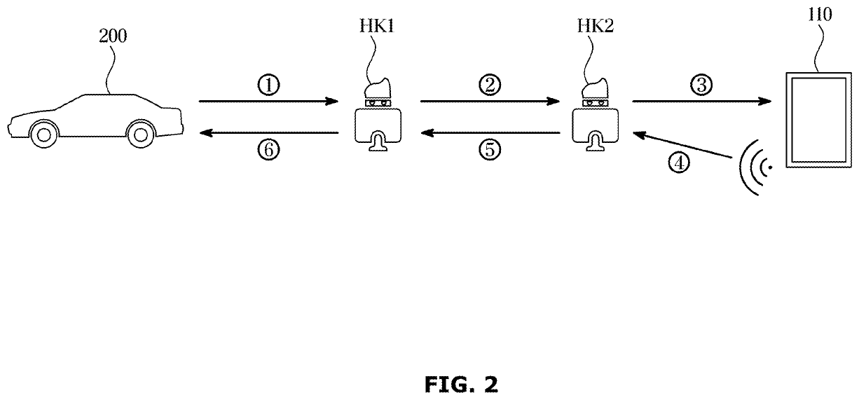

As described above, when the wireless anchor 120 is registered to the digital key 110 and the wireless anchor 120 and the digital key 110 are within a predetermined distance range, the digital key 110 may be deactivated. Referring first to FIG. 2 for this, a conventional sniffing of wireless data between the vehicle and the digital key 110 will be described.

Referring to FIG. 2, a vehicle enabling a use of the digital key 110, which parked in a parking lot or the like, continuously emits a wireless signal. A first hacker HK1 located adjacent to the vehicle may steal the emitted wireless signal (\textcircled{1}). Then, the first hacker HK1 transmits the wireless signal stolen from the vehicle to a second hacker HK2 located adjacent to digital key 110 possessed by a user (\textcircled{2}). The second hacker (HK2) emits the relayed and received wireless signal toward the digital key 110 possessed by the user (\textcircled{3}). Consequently, the digital key 110 recognizes that the vehicle has been approached, and then the digital key 110 is activated and transmits an activated response signal (\textcircled{4}). The second hacker HK2 steals the response signal transmitted from the digital key 110 and transmits the stolen signal to the first hacker HK1 (\textcircled{5}). The first hacker HK1 may create and secure a fake digital key 110 by using the response signal sent from the digital key 110 transmitted from the second hacker HK2, and the secured fake digital key 110 may be used to control the vehicle (\textcircled{6}).

In the above manner, the first hacker HK1 located adjacent to the vehicle and the second hacker HK2 located adjacent to the digital key 110 of the corresponding vehicle may steal the response signal of the digital key 110 and then freely control the vehicle owned by the user. During the above processes, the user may not be aware of whether the wireless signal of the digital key 110 has been stolen.

To prevent this, in some implementations, the digital key 110 may search for and register the wireless anchor 120 in a vicinity when the digital key 110 is located at a distance greater than or equal to a predetermined distance from the location where the vehicle is located. In addition, when the digital key 110 and the registered wireless anchor 120 maintain a communication-connected state, the digital key 110 is deactivated, so that the wireless signal for controlling the vehicle may not be transmitted.

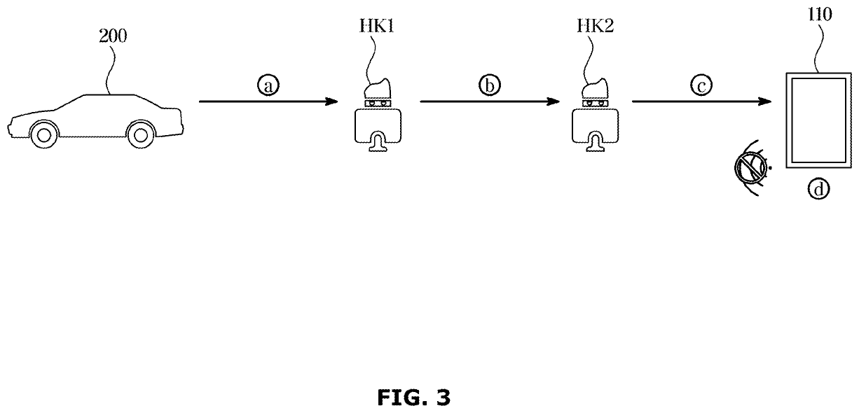

Referring to FIG. 3 for a more detailed description, a vehicle that may use the digital key 110, which parked in a parking lot or the like continuously emits the wireless signal. The first hacker HK1 located adjacent to the vehicle may steal the emitted wireless signal (\textcircled{a}). Then, the first hacker HK1 transmits the wireless signal stolen from the vehicle to the second hacker HK2 located adjacent to the digital key 110 possessed by the user (\textcircled{b}). The second hacker (HK2) emits the relayed and received wireless signal toward the digital key 110 possessed by the user (\textcircled{c}). The digital key 110 maintains the communication-connected state with the registered wireless anchor 120, so that the digital key 110 is deactivated (\textcircled{d}). Consequently, the second hacker HK2 may not steal the response signal transmitted from the digital key 110, so that the vehicle may be prevented from being stolen.

Herein, if necessary, the digital key 110 may log what is detected in the vehicle's wireless signal, and an alarm or the like may be generated as needed. In addition, such log or alarm generation may be performed only in a state in which the digital key 110 is communicatively connected with the registered wireless anchor 120.

As described above, the digital key 110 may store information on the registered wireless anchor 120, and may store the information on the registered wireless anchor 120 in a server 300 located outside as needed. The server 300 may be provided by a company that provides the digital key 110, and may be stored in a database using an identification number of the digital key 110.

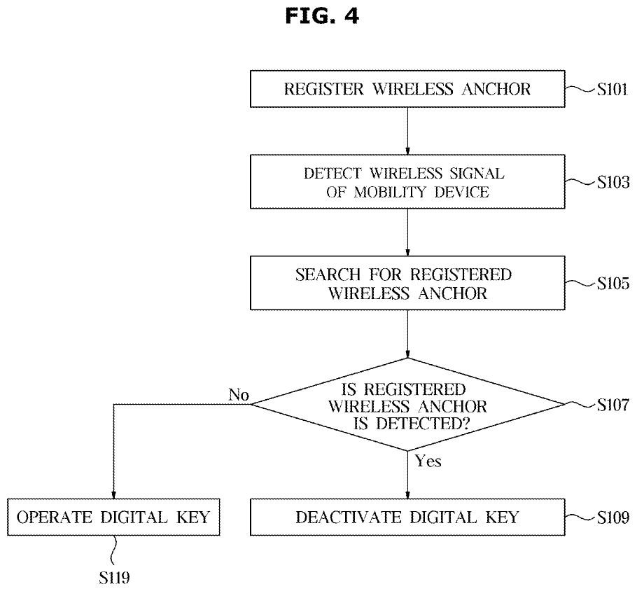

On the other hand, referring to FIG. 4, an anti-theft method will be described. While describing the anti-theft method, it will also be described with reference to the drawings shown in FIG. 1 to FIG. 3.

The wireless anchor 120 is registered in the digital key 110 (S101).

Before using the digital key 110, the user searches for wireless anchors 120 arranged nearby and registers one or more of the searched wireless anchors 120 to the digital key 110. In other words, the digital key 110 may be registered with one or more of the searched wireless anchors 120. Herein, one or more wireless anchors 120 registered to the digital key 110 may be registered one more at one place or at least one each at a plurality of places.

For example, the user may park the vehicle in a parking lot of a house and register one or more electronic devices capable of wireless communication (e.g., a refrigerator, a television, and the like) located in the house as the wireless anchor 120. In addition, the user may register a wireless AP or a router, which installed in a company, in the digital key 110 as the wireless anchor 120.

As such, the wireless anchor 120 registered to the digital key 110 may be selected from any electronic device placed in a location where it is certainly known that the vehicle is not in use, and the electronic device placed in a location other than a home or office may be selected as needed.

The wireless signal of the mobility device 200 is detected (S103).

The digital key 110 detects the wireless signal emitted from the mobility device 200 (e.g., vehicle). The mobility device 200 continuously emits the wireless signal to confirm a location of the digital key 110 approaching the vehicle, and the digital key 110 detects the wireless signal emitted from the mobility device 200.

The fact that the digital key 110 detects the wireless signal of the mobility device 200 may be a case in which a user approaches the mobility device 200 while holding the digital key 110, or a case in which a hacker approaches the digital key 110 by stealing the wireless signal generated by the mobility device 200.

The registered wireless anchor 120 is searched (S105).

In response to the wireless signal emitted from the mobility device 200 being detected in S103, the digital key 110 searches whether the wireless anchor 120 registered in the vicinity exists. In S105, the registered wireless anchor 120 is the wireless anchor 120 registered to the digital key 110 in S101 and is the wireless anchor 120 placed in a location where the user does not use the mobility device 200.

Whether the registered wireless anchor 120 is detected is confirmed (S107).

The digital key 110 searches whether the registered wireless anchor 120 exists in S105 and identifies whether to be detected. In other words, S107 is a process of the digital key 110 confirms whether the wireless signal of the wireless anchor 120 registered in the vicinity exists.

When the registered wireless anchor 120 is detected, the digital key 110 is deactivated (S109).

In response to the signal of the registered wireless anchor 120 around the digital key 110 is detected in S107, the digital key 110 is deactivated. In other words, in S109, when the registered wireless anchor 120 around the digital key 110 exists, the digital key 110 is deactivated so that the digital key does not normally operate. When the digital key 110 is deactivated, no response signal may be generated for the user to respond to the wireless signal of the mobility device 200 using the digital key 110 and also no corresponding signal may not be generated although a user manipulates the digital key 110 to control the mobility device 200.

When the registered wireless anchor 120 is not detected, the digital key 110 operates (S119).

When the signal of the registered wireless anchor 120 around the digital key 110 is not detected in S107, the digital key 110 operates normally. In other words, the digital key 110 generates a response signal in response to the wireless signal generated by the mobility device 200. Furthermore, the user may normally perform various controls of the mobility device 200 using the digital key 110.

As is apparent from the above, in some implementations, by setting the wireless anchor to the digital key, the mobility device may be prevented from being stolen by setting a double safety device to prevent an attack of sniffing wireless data when using the digital key.

Further, in some implementations, various devices capable of wireless communication may be used for the wireless anchor, so that it may be freely used in various environments.

On the other hand, the above-described implementations may be implemented in the form of a recording medium storing instructions executable by a computer. The instructions may be stored in the form of program code. When the instructions are executed by a processor, a program module is generated by the instructions so that the operations of the disclosed implementations may be carried out. The recording medium may be implemented as a computer-readable recording medium.

The computer-readable recording medium includes all types of recording media storing data readable by a computer system. Examples of the computer-readable recording medium include a Read Only Memory (ROM), a Random Access Memory (RAM), a magnetic tape, a magnetic disk, a flash memory, an optical data storage device, or the like.

What is claimed is:

1. An anti-theft system, comprising:
a digital key configured to wirelessly control an operation of a mobility device; and
a wireless anchor configured to generate a wireless signal,
wherein the digital key is configured to, based on the wireless signal being detected, be deactivated.

2. The anti-theft system of claim 1, wherein the digital key is configured to:
register and store the wireless anchor, and
based on the wireless signal from the registered wireless anchor being detected, be deactivated.

3. The anti-theft system of claim 1, wherein the wireless anchor is spaced apart from the mobility device by at least a predetermined distance.

4. The anti-theft system of claim 3, wherein the wireless anchor is spaced further apart from the mobility device than a distance that allows the digital key to generate a signal responding to a wireless signal from the mobility device.

5. The anti-theft system of claim 1, wherein the wireless anchor is configured to generate a wireless signal based on at least one communication method among Bluetooth low energy (BLU) communication, ultra wideband (UWB) communication, wireless internet network communication, or mobile communication network communication.

6. The anti-theft system of claim 1, wherein the digital key is configured to, based on a wireless signal from the mobility device being detected, determine whether the wireless signal generated from the wireless anchor is detected.

7. The anti-theft system of claim 6, wherein the digital key is configured to confirm whether the wireless signal generated from a pre-registered wireless anchor is detected.

8. The anti-theft system of claim 1, wherein the digital key is configured to, based on the wireless signal generated from the wireless anchor being detected, be deactivated such that a signal for controlling the mobility device is not generated.

9. The anti-theft system of claim 1, wherein the deactivation of the digital key blocks the digital key from generating a signal responding to a wireless signal of the mobility device.

10. An anti-theft method, comprising:
detecting, by a digital key, a wireless signal emitted from a mobility device to thereby control an operation of the mobility device;
detecting, by the digital key, a wireless anchor configured to generate a wireless signal; and
deactivating, based on the wireless signal generated by the wireless anchor being detected by the digital key, the digital key.

11. The anti-theft method of claim 10, further comprising registering the wireless anchor to the digital key.

12. The anti-theft method of claim 11, wherein detecting the wireless anchor further includes detecting a wireless anchor registered to the digital key.

13. The anti-theft method of claim 10, wherein the wireless anchor is spaced apart from the mobility device by at least a predetermined distance.

14. The anti-theft method of claim 13, wherein the wireless anchor is spaced further apart from the mobility device than a distance that allows the digital key to generate a signal responding to a wireless signal from the mobility device.

15. The anti-theft method of claim 10, wherein the wireless anchor generates a wireless signal based on at least one communication method among Bluetooth low energy (BLU) communication, ultra wideband (UWB) communication, wireless internet network communication, or mobile communication network communication.

16. The anti-theft method of claim 10, wherein deactivating the digital key includes blocking signal generation for controlling the mobility device.

17. The anti-theft method of claim 10, wherein deactivating the digital key includes blocking the digital key from generating a signal responding to a wireless signal from the mobility device.
